(19) United States
(12) Patent Application Publication
(10) Pub. No.: US 2025/0100558 A1
(43) Pub. Date: Mar. 27, 2025

(54) VEHICLE SYSTEM AND METHOD FOR INFORMING AUTHORITIES ABOUT ROAD CONDITIONS

(71) Applicant: GM Global Technology Operations LLC, Detroit, MI (US)

(72) Inventors: Manoj Kumar Sharma, Troy, MI (US); Donald K. Grimm, Utica, MI (US); Michael Alan Losh, Rochester Hills, MI (US)

(21) Appl. No.: 18/471,556

(22) Filed: Sep. 21, 2023

(51) Int. Cl. B60W 40/06; G07C 5/00

(52) U.S. Cl. CPC B60W 40/06; G07C 5/008; B60W 2420/403; B60W 2554/4041; B60W 2555/20

(57) ABSTRACT

A system for notifying an authority about road conditions for a vehicle may include a plurality of vehicle sensors, a vehicle communication system, and a controller in electrical communication with the plurality of vehicle sensors and the vehicle communication system. The controller is programmed to identify a measurement trigger. The controller is further programmed to perform a measurement of an environment surrounding the vehicle using the plurality of vehicle sensors in response to identifying the measurement trigger. The controller is further programmed to determine a measurement classification based at least in part on the measurement. The controller is further programmed to transmit the measurement and the measurement classification to a remote server system using the vehicle communication system.

### INTRODUCTION

The present disclosure relates to systems and methods for notifying an authority about road conditions.

To increase occupant awareness and convenience, vehicles may be equipped with perception and sensing systems configured to monitor and measure aspects of the environment surrounding the vehicle. Perception and sensing systems may include, for example, camera systems, LiDAR (light detection and ranging) systems, and/or the like. Perception and sensing systems may be used as part of a vehicle system to enable features such as, for example, advanced driver assistance systems (ADAS), automated driving systems (ADS), vehicle security systems, and/or the like. However, current perception and sensing systems may not gather information about road conditions in the environment surrounding the vehicle and transmit information about road conditions to authorities. Therefore, authorities may require manual information collection about road conditions.

Thus, while perception and sensing systems and methods achieve their intended purpose, there is a need for a new and improved system and method for notifying an authority about road conditions.

### SUMMARY

According to several aspects, a system for notifying an authority about road conditions for a vehicle is provided. The system may include a plurality of vehicle sensors, a vehicle communication system, and a controller in electrical communication with the plurality of vehicle sensors and the vehicle communication system. The controller is programmed to identify a measurement trigger. The controller is further programmed to perform a measurement of an environment surrounding the vehicle using the plurality of vehicle sensors in response to identifying the measurement trigger. The controller is further programmed to determine a measurement classification based at least in part on the measurement. The controller is further programmed to transmit the measurement and the measurement classification to a remote server system using the vehicle communication system.

In another aspect of the present disclosure, the plurality of vehicle sensors includes at least a global navigation satellite system (GNSS). To identify the measurement trigger, the controller is further programmed to determine a location of the vehicle using the GNSS. To identify the measurement trigger, the controller is further programmed to compare the location of the vehicle to a predetermined geofenced location area. To identify the measurement trigger, the controller is further programmed to identify the measurement trigger in response to determining that the location of the vehicle is within the predetermined geofenced location area.

In another aspect of the present disclosure, to identify the measurement trigger, the controller is further programmed to receive a trigger request from at least one of: an occupant of the vehicle and an authority. To identify the measurement trigger, the controller is further programmed to identify the measurement trigger based at least in part on the trigger request.

In another aspect of the present disclosure, the plurality of vehicle sensors includes at least a camera system. To perform the measurement of the environment surrounding the vehicle, the controller is further programmed to capture one or more images of a remote vehicle using the camera system based at least in part on the trigger request. The trigger request includes at least one of: a remote vehicle license plate number, a remote vehicle model, and a remote vehicle color.

In another aspect of the present disclosure, to determine the measurement classification, the controller is further programmed to determine the measurement classification of the one or more images to be a law enforcement measurement classification in response to determining that remote vehicle in the one or more images includes at least one of: the remote vehicle license plate number, the remote vehicle model, and the remote vehicle color.

In another aspect of the present disclosure, to identify the measurement trigger, the controller is further programmed to perform a trigger measurement using the plurality of vehicle sensors. To identify the measurement trigger, the controller is further programmed to identify a road condition in the trigger measurement using a machine learning algorithm. The road condition includes one of a normal road condition and an abnormal road condition. To identify the measurement trigger, the controller is further programmed to identify the measurement trigger in response to determining that the road condition is the abnormal road condition.

In another aspect of the present disclosure, the plurality of vehicle sensors includes at least a camera system. To perform the measurement of the environment surrounding the vehicle, the controller is further programmed to capture one or more images using the camera system. To perform the measurement of the environment surrounding the vehicle, the controller is further programmed to store the one or more images in a non-transitory memory of the controller.

In another aspect of the present disclosure, the plurality of vehicle sensors includes at least a global navigation satellite system (GNSS). To determine the measurement classification, the controller is further programmed to determine a location of the vehicle using the GNSS. To determine the measurement classification, the controller is further programmed to compare the location of the vehicle to a predetermined plurality of point-of-interest (POI) locations. To determine the measurement classification, the controller is further programmed to determine the measurement classification of the one or more images to be a tourist measurement classification in response to determining that the location of the vehicle is within a predetermined distance from at least one of the plurality of POI locations.

In another aspect of the present disclosure, to determine the measurement classification, the controller is further programmed to identify a traffic sign in the one or more images using a computer vision algorithm. To determine the measurement classification, the controller is further programmed to calculate a correlation value between the one or more images and a reference image using the computer vision algorithm. To determine the measurement classification, the controller is further programmed to determine the measurement classification of the one or more images to be a damaged traffic sign measurement classification in response to identifying the traffic sign in the one or more images and in response to determining that the correlation value is less than a predetermined correlation threshold.

In another aspect of the present disclosure, to determine the measurement classification, the controller is further programmed to detect an adverse road condition in the one or more images using a machine learning algorithm. The adverse road condition includes at least one of: a foreign object on a roadway, an animal on the roadway, and a damaged roadway surface. To determine the measurement classification, the controller is further programmed to determine a risk value of the adverse road condition. To determine the measurement classification, the controller is further programmed to determine the measurement classification of the one or more images to be an adverse road condition measurement classification based at least in part on the adverse road condition and the risk value.

According to several aspects, a method for notifying an authority about road conditions for a vehicle is provided. The method may include performing a measurement of an environment surrounding the vehicle using a plurality of vehicle sensors. The method further may include determining a measurement classification based at least in part on the measurement. The method further may include transmitting the measurement and the measurement classification to an authority.

In another aspect of the present disclosure, performing the measurement and determining the measurement classification further may include capturing one or more images of the environment surrounding the vehicle using a camera system. Performing the measurement and determining the measurement classification further may include detecting debris in the one or more images using a machine learning algorithm. Performing the measurement and determining the measurement classification further may include determining a risk value of the debris. Performing the measurement and determining the measurement classification further may include determining the measurement classification of the one or more images to be a debris measurement classification based at least in part on the debris and the risk value.

In another aspect of the present disclosure, performing the measurement and determining the measurement classification further may include performing one or more measurements of the environment surrounding the vehicle using an infrared sensor configured to detect thermal radiation. Performing the measurement and determining the measurement classification further may include detecting fire in the environment surrounding the vehicle based at least in part on the one or more measurements. Performing the measurement and determining the measurement classification further may include determining the measurement classification of the one or more measurements to be a fire measurement classification in response to detecting fire in the environment surrounding the vehicle.

In another aspect of the present disclosure, performing the measurement and determining the measurement classification further may include capturing one or more images of the environment surrounding the vehicle using a camera system. Performing the measurement and determining the measurement classification further may include detecting graffiti in the one or more images using a machine learning algorithm. Performing the measurement and determining the measurement classification further may include determining the measurement classification of the one or more images to be a graffiti measurement classification in response to detecting graffiti in the one or more images.

In another aspect of the present disclosure, performing the measurement and determining the measurement classification further may include capturing one or more images of the environment surrounding the vehicle using a camera system. Performing the measurement and determining the measurement classification further may include detecting criminal activity in the one or more images using a machine learning algorithm. Performing the measurement and determining the measurement classification further may include determining the measurement classification of the one or more images to be a criminal activity measurement classification in response to detecting criminal activity in the one or more images.

In another aspect of the present disclosure, performing the measurement and determining the measurement classification further may include capturing one or more images of the environment surrounding the vehicle using a camera system. Performing the measurement and determining the measurement classification further may include detecting water on a roadway in the one or more images using a machine learning algorithm. Performing the measurement and determining the measurement classification further may include determining the measurement classification of the one or more images to be a flood measurement classification in response to detecting water on the roadway in the one or more images.

In another aspect of the present disclosure, performing the measurement and determining the measurement classification further may include capturing a plurality of images of the environment surrounding the vehicle using a camera system. Performing the measurement and determining the measurement classification further may include detecting one or more points-of-interest (POIs) in the plurality of images using a machine learning algorithm. Performing the measurement and determining the measurement classification further may include determining the measurement classification of the plurality of images to be a tourist measurement classification in response to detecting the one or more POIs in the plurality of images. Performing the measurement and determining the measurement classification further may include generating a film including the plurality of images. Performing the measurement and determining the measurement classification further may include displaying the film to an occupant of the vehicle.

According to several aspects, a system for notifying an authority about road conditions for a vehicle is provided. The system may include a camera system. The system further may include a global navigation satellite system (GNSS). The system further may include a vehicle communication system. The system further may include a controller in electrical communication with the camera system, the GNSS, and the vehicle communication system. The controller is programmed to identify a measurement trigger. The controller is further programmed to capture one or more images of an environment surrounding the vehicle using the camera system in response to identifying the measurement trigger. The controller is further programmed to determine a location of each of the one or more images using the GNSS. The controller is further programmed to determine a measurement classification of each of the one or more images. The controller is further programmed to transmit the one or more images, the measurement classification of each of the one or more images, and the location of each of the one or more images to a remote server system using the vehicle communication system. The remote server system is configured to be accessed by the authority.

In another aspect of the present disclosure, the measurement trigger includes at least one of: a predetermined geofenced location area, a trigger request initiated by an occupant of the vehicle, and a trigger request sent by the authority.

In another aspect of the present disclosure, to determine the measurement classification, the controller is further programmed to identify a road condition in the one or more images. The road condition includes at least one of: a point-of-interest (POI), a damaged traffic sign, a foreign object on a roadway, an animal on the roadway, a damaged roadway surface, a fire in the environment surrounding the vehicle, graffiti, criminal activity, and water on the roadway. To determine the measurement classification, the controller is further programmed to determine the measurement classification based at least in part on the road condition in the one or more images.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for notifying an authority about road conditions for a vehicle, according to an exemplary embodiment;

FIG. 2 is a flowchart of the method for notifying an authority about road conditions for a vehicle, according to an exemplary embodiment;

FIG. 3 is a flowchart of a first exemplary embodiment of a method for identifying a measurement trigger, according to an exemplary embodiment;

FIG. 4 is a flowchart of a second exemplary embodiment of a method for identifying a measurement trigger, according to an exemplary embodiment; and

FIG. 5 is a flowchart of a third exemplary embodiment of a method for identifying a measurement trigger, according to an exemplary embodiment.

### DETAILED DESCRIPTION

The following description is merely exemplary in nature and is not intended to limit the present disclosure, application, or uses.

Various conditions encountered on or near roadways may require attention and/or resolution from civil authorities, including, for example, a law enforcement agency, a fire department, a road maintenance agency, and/or the like. However, civil authorities may be tasked with servicing a large and/or complex jurisdiction and may rely on manual surveying and/or reporting procedures to identify issues needing attention. Therefore, the present disclosure provides a new and improved system and method for notifying an authority about road conditions.

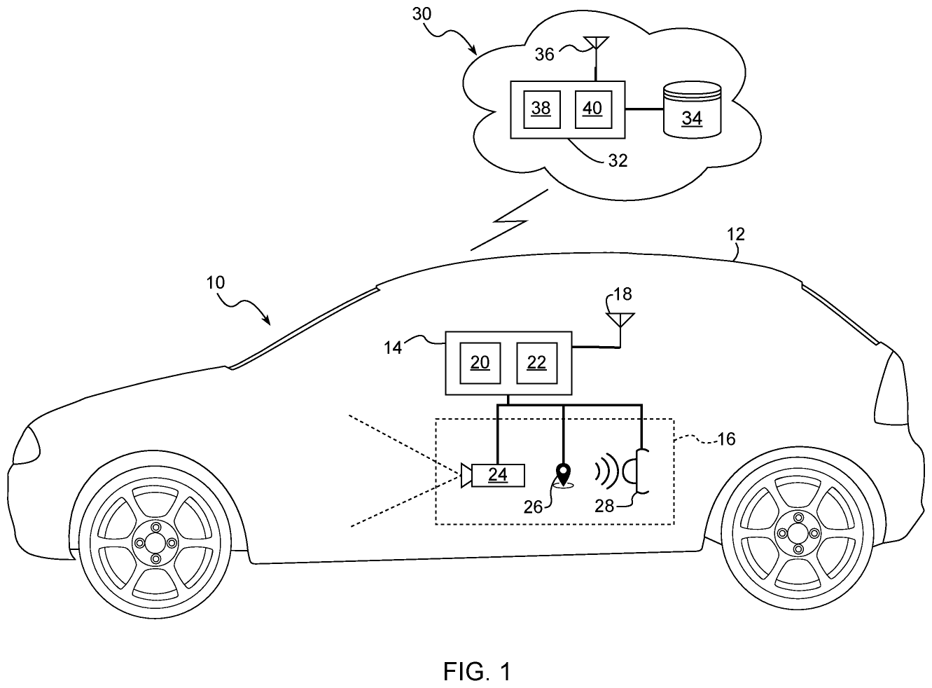

Referring to FIG. 1, a system for notifying an authority about road conditions for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, a plurality of vehicle sensors 16, and a vehicle communication system 18.

The controller 14 is used to implement a method 100 for notifying an authority about road conditions for a vehicle, as will be described below. The controller 14 includes at least one processor 20 and a non-transitory computer readable storage device or media 22. The processor 20 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions. The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the plurality of vehicle sensors 16 and the vehicle communication system 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure.

The plurality of vehicle sensors 16 are used to acquire information relevant to the vehicle 12. In an exemplary embodiment, the plurality of vehicle sensors 16 includes at least a camera system 24, a global navigation satellite system (GNSS) 26, and an infrared sensor 28.

In another exemplary embodiment, the plurality of vehicle sensors 16 further includes sensors to determine performance data about the vehicle 12. In a non-limiting example, the plurality of vehicle sensors 16 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the plurality of vehicle sensors 16 further includes sensors to determine information about an environment within the vehicle 12. In a non-limiting example, the plurality of vehicle sensors 16 further includes at least one of a seat occupancy sensor, a cabin air temperature sensor, a cabin motion detection sensor, a cabin camera, a cabin microphone, and/or the like.

In another exemplary embodiment, the plurality of vehicle sensors 16 further includes sensors to determine information about an environment surrounding the vehicle 12. In a non-limiting example, the plurality of vehicle sensors 16 further includes at least one of an ambient air temperature sensor, and/or a barometric pressure sensor.

In another exemplary embodiment, at least one of the plurality of vehicle sensors 16 is a perception sensor capable of perceiving objects and/or measuring distances in the environment surrounding the vehicle 12. In a non-limiting example, the plurality of vehicle sensors 16 includes a stereoscopic camera having distance measurement capabilities. In one example, at least one of the plurality of vehicle sensors 16 is affixed inside of the vehicle 12, for example, in a headliner of the vehicle 12, having a view through a windscreen of the vehicle 12. In another example, at least one of the plurality of vehicle sensors 16 is affixed outside of the vehicle 12, for example, on a roof of the vehicle 12, having a view of the environment surrounding the vehicle 12. It should be understood that various additional types of perception sensors, such as, for example, LiDAR sensors, ultrasonic ranging sensors, radar sensors, and/or time-of-flight sensors are within the scope of the present disclosure. The plurality of vehicle sensors 16 are in electrical communication with the controller 14 as discussed above.

The camera system 24 is a perception sensor used to capture images and/or videos of the environment surrounding the vehicle 12. In an exemplary embodiment, the camera system 24 includes a photo and/or video camera which is positioned to view the environment surrounding the vehicle 12. In a non-limiting example, the camera system 24 includes a camera affixed inside of the vehicle 12, for example, in a headliner of the vehicle 12, having a view through the windscreen. In another non-limiting example, the camera system 24 includes a camera affixed outside of the vehicle 12, for example, on a roof of the vehicle 12, having a view of the environment in front of the vehicle 12.

In another exemplary embodiment, the camera system 24 is a surround view camera system including a plurality of cameras (also known as satellite cameras) arranged to provide a view of the environment adjacent to all sides of the vehicle 12. In a non-limiting example, the camera system 24 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera system 24 further includes an additional rear-view camera mounted near a center high mounted stop lamp of the vehicle 12.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The GNSS 26 is used to determine a geographical location of the vehicle 12. In an exemplary embodiment, the GNSS 26 is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the vehicle 12 based on the signals received by the GPS receiver antenna. In an exemplary embodiment, the GNSS 26 additionally includes a map. The map includes information about infrastructure such as municipality borders, roadways, railways, sidewalks, buildings, and the like. Therefore, the geographical location of the vehicle 12 is contextualized using the map information. In a non-limiting example, the map is retrieved from a remote source using a wireless connection. In another non-limiting example, the map is stored in a database of the GNSS 26. It should be understood that various additional types of satellite-based radionavigation systems, such as, for example, the Global Positioning System (GPS), Galileo, GLONASS, and the BeiDou Navigation Satellite System (BDS) are within the scope of the present disclosure. It should be understood that the GNSS 26 may be integrated with the controller 14 (e.g., on a same circuit board with the controller 14 or otherwise a part of the controller 14) without departing from the scope of the present disclosure.

The infrared sensor 28 is used to detect thermal radiation in the environment surrounding the vehicle 12. In an exemplary embodiment, the infrared sensor 28 determines a temperature of objects in the environment surrounding the vehicle 12 by measuring thermal radiation emitted by objects in the environment surrounding the vehicle 12. In a non-limiting example, the infrared sensor 28 includes an infrared sensor element and a signal processing unit. In some embodiments, the infrared sensor 28 further may include one or more lenses to focus the infrared radiation onto the infrared sensor element. The infrared sensor element detects infrared radiation and converts infrared radiation into electrical signals. The electrical signals are then sent to the signal processing unit. The signal processing unit interprets the data and calculates the temperature of objects in the environment surrounding the vehicle 12 based on the intensity of the detected infrared radiation. It should be understood that additional devices operable for non-contact temperature measurement of objects in the environment surrounding the vehicle 12 are within the scope of the present disclosure.

The vehicle communication system 18 is used by the controller 14 to communicate with other systems external to the vehicle 12. For example, the vehicle communication system 18 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems). In certain embodiments, the vehicle communication system 18 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 18 may further include an embedded universal integrated circuit card (eUICC) configured to store at least one cellular connectivity configuration profile, for example, an embedded subscriber identity module (eSIM) profile. The vehicle communication system 18 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 18 may include one or more antennas and/or communication transceivers for receiving and/or transmitting signals, such as cooperative sensing messages (CSMs). The vehicle communication system 18 is configured to wirelessly communicate information between the vehicle 12 and another vehicle. Further, the vehicle communication system 18 is configured to wirelessly communicate information between the vehicle 12 and infrastructure or other vehicles. It should be understood that the vehicle communication system 18 may be integrated with the controller 14 (e.g., on a same circuit board with the controller 14 or otherwise a part of the controller 14) without departing from the scope of the present disclosure. The vehicle communication system 18 is in electrical communication with the controller 14 as discussed above.

With continued reference to FIG. 1, a remote server system is illustrated and generally indicated by reference number 30. The remote server system 30 includes a server controller 32 in electrical communication with a server database 34 and a server communication system 36. In a non-limiting example, the remote server system 30 is located in a server farm, datacenter, or the like, and connected to the internet.

The server controller 32 includes at least one server processor 38 and a server non-transitory computer readable storage device or server media 40. The description of the type and configuration given above for the controller 14 also applies to the server controller 32. In some examples, the server controller 32 may differ from the controller 14 in that the server controller 32 is capable of a higher processing speed, includes more memory, includes more inputs/outputs, and/or the like. In a non-limiting example, the server processor 38 and server media 40 of the server controller 32 are similar in structure and/or function to the processor 20 and the media 22 of the controller 14, as described above.

The server database 34 is used to store measurements and measurement classifications, as will be discussed in greater detail below. In an exemplary embodiment, the server database 34 includes one or more mass storage devices, such as, for example, hard disk drives, magnetic tape drives, magneto-optical disk drives, optical disks, solid-state drives, and/or additional devices operable to store data in a persisting and machine-readable fashion. In some examples, the one or more mass storage devices may be configured to provide redundancy in case of hardware failure and/or data corruption, using, for example, a redundant array of independent disks (RAID). In a non-limiting example, the server controller 32 may execute software such as, for example, a database management system (DBMS), allowing data stored on the one or more mass storage devices to be organized and accessed.

The server communication system 36 is used to communicate with external systems, such as, for example, the controller 14 via the vehicle communication system 18. In a non-limiting example, server communication system 36 is similar in structure and/or function to the vehicle communication system 18, as described above. In some examples, the server communication system 36 may differ from the vehicle communication system 18 in that the server communication system 36 is capable of higher power signal transmission, more sensitive signal reception, higher bandwidth transmission, additional transmission/reception protocols, and/or the like.

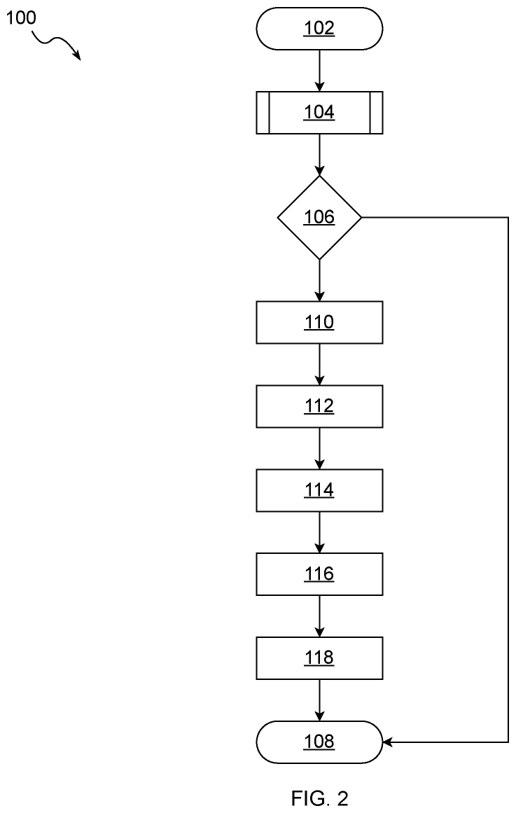

Referring to FIG. 2, a flowchart of the method 100 for notifying an authority about road conditions for a vehicle is shown. The method 100 begins at block 102 and proceeds to block 104. At block 104, the controller 14 identifies a measurement trigger. In the scope of the present disclosure, the measurement trigger is an event which prompts the controller 14 to perform a measurement using the plurality of vehicle sensors 16, as will be discussed in greater detail below. Identification of the measurement trigger will be discussed in greater detail below. After block 104, the method 100 proceeds to block 106.

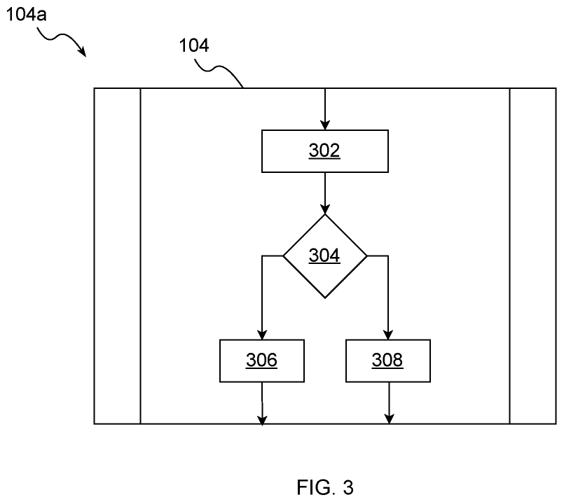

Referring to FIG. 3, a first exemplary embodiment 104a of block 104 is shown. The first exemplary embodiment 104a begins at block 302. At block 302, the controller 14 determines a location of the vehicle 12 using the GNSS 26. After block 302, the first exemplary embodiment 104a proceeds to block 304. At block 304, the location of the vehicle 12 determined at block 302 is compared to a predetermined geofenced location area. In the scope of the present disclosure, the predetermined geofenced location area is a geographical area which has been predetermined as an area of interest for performing measurements. In a non-limiting example, the predetermined geofenced location area includes one or more road segments, a neighborhood, a city block, and/or the like. In an exemplary embodiment, the predetermined geofenced location may be updated by the remote server system 30 and received by the controller 14 using the vehicle communication system 18, using, for example, a system learning and update (SLU) data collection system. If the location of the vehicle 12 determined at block 302 is not within the predetermined geofenced location area, the first exemplary embodiment 104a proceeds to block 306. If the location of the vehicle 12 determined at block 302 is within the predetermined geofenced location area, the first exemplary embodiment 104a proceeds to block 308.

At block 306, the measurement trigger is not identified. After block 306, the first exemplary embodiment 104a is concluded, and the method 100 proceeds as described below. At block 308, the measurement trigger is identified. After block 308, the first exemplary embodiment 104a is concluded, and the method 100 proceeds as described below.

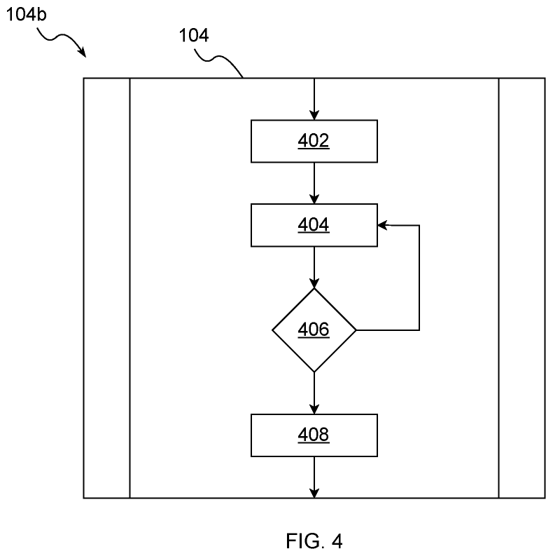

Referring to FIG. 4, a second exemplary embodiment 104b of block 104 is shown. The second exemplary embodiment 104b begins at block 402. At block 402, the controller 14 receives a trigger request. In the scope of the present disclosure, the trigger request is a request for the system 10 to perform measurements in response to determining that one or more conditions have been met. The trigger request contains the one or more conditions. In an exemplary embodiment, the trigger request is received from an occupant of the vehicle 12. In a non-limiting example, the occupant of the vehicle 12 uses a human-machine interface (HMI) to input the trigger request. For example, the trigger request may include a request from the occupant to capture images of a particular point-of-interest (POI). In the scope of the present disclosure, the POI includes, for example, a business, a restaurant, a vehicle service center, a hospital, a police station, a gas station, a vehicle charging station, a recreational area, a nature preserve area, a museum, a theater, a tourist attraction, a statue, a monument, a memorial, and/or the like. In another exemplary embodiment, the trigger request is received from an authority. In the scope of the present disclosure, the authority includes organizations and/or individuals who are responsible for maintenance of public roadway infrastructure, including, for example, a law enforcement agency, a fire department, a road maintenance agency, and/or the like. In a non-limiting example, the authority provides a trigger request to the remote server system 30. After block 402, the second exemplary embodiment 104b proceeds to block 404.

At block 404, the controller 14 uses the plurality of vehicle sensors 16 to perform a measurement of the environment surrounding the vehicle 12. In an exemplary embodiment, the controller 14 uses the camera system 24 to capture an image of the environment surrounding the vehicle 12. After block 404, the second exemplary embodiment 104b proceeds to block 406.

At block 406, the measurement performed at block 404 is compared to the trigger request received at block 402. For example, a law enforcement agency may provide a trigger request including a remote vehicle license plate number, a remote vehicle model, and/or a remote vehicle color. If the measurement performed at block 404 (i.e., the image captured at block 404) includes the remote vehicle license plate number, the remote vehicle model, and/or the remote vehicle color, the measurement is determined to match the trigger request. In a non-limiting example, determination of the remote vehicle license plate number is performed according to methods discussed in “Automatic Number Plate Recognition: A Detailed Survey of Relevant Algorithms” by Lubna et al. (Sensors, 21, 328 Apr. 2021), the entire contents of which is hereby incorporated by reference.

In another example, a road maintenance agency may provide a trigger request including all types of traffic signs. Therefore, if the measurement performed at block 404 (i.e., the image captured at block 404) includes a traffic sign, the measurement is determined to match the trigger request. If the measurement is not determined to match the trigger request, the second exemplary embodiment 104b returns to block 404 to capture perform a new measurement. If the measurement is determined to match the trigger request, the second exemplary embodiment 104b proceeds to block 408.

At block 408, the measurement trigger is identified. After block 408, the second exemplary embodiment 104b is concluded, and the method 100 proceeds as described below.

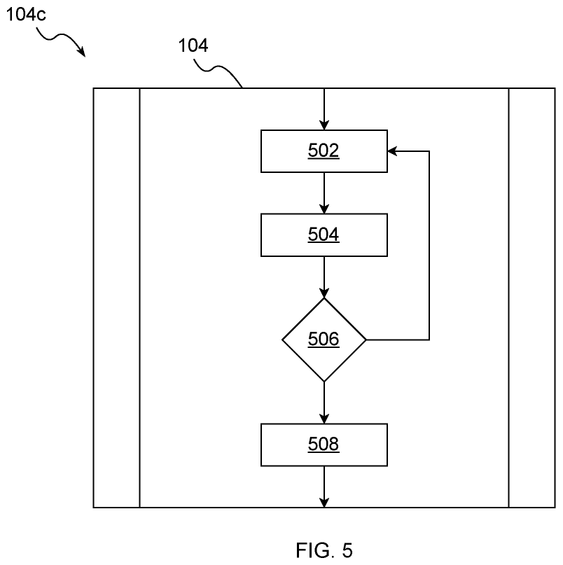

Referring to FIG. 5, a third exemplary embodiment 104c of block 104 is shown. The third exemplary embodiment 104c begins at block 502. At block 502, the controller 14 uses the plurality of vehicle sensors 16 to perform a trigger measurement of the environment surrounding the vehicle 12. In the scope of the present disclosure, a trigger measurement is a measurement used for the purpose of identifying the measurement trigger. In an exemplary embodiment, the controller 14 uses the camera system 24 to capture an image of the environment surrounding the vehicle 12. After block 502, the third exemplary embodiment 104c proceeds to block 504.

At block 504, the controller 14 evaluates the trigger measurement using a machine learning algorithm. In an exemplary embodiment, the machine learning algorithm is configured to identify a road condition in the trigger measurement. In the scope of the present disclosure, the road condition includes a normal road condition and an abnormal road condition. In the scope of the present disclosure, the abnormal road condition includes, for example, a foreign object on the roadway, an animal on the roadway, water on the roadway, a damaged roadway surface, a damaged traffic sign, a fire, criminal activity, and/or graffiti.

In a non-limiting example, the machine learning algorithm includes multiple layers, including an input layer and an output layer, as well as one or more hidden layers. The input layer receives the trigger measurement as an input. The input is then passed on to the hidden layers. Each hidden layer applies a transformation (e.g., a non-linear transformation) to the data and passes the result to the next hidden layer until the final hidden layer. The output layer produces the road condition.

To train the machine learning algorithm, a dataset of inputs and their corresponding road conditions is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to classify new input data.

After sufficient training of the machine learning algorithm, the algorithm is capable of accurately and precisely determining road condition based on the trigger measurement. By adjusting the weights between the nodes in each hidden layer during training, the algorithm “learns” to recognize patterns in the data that are indicative of road condition. After block 504, the third exemplary embodiment 104c proceeds to block 506.

At block 506, if the abnormal road condition is not identified at block 504, the third exemplary embodiment 104c returns to block 502 to perform another measurement. If the abnormal road condition is identified at block 504, the third exemplary embodiment 104c proceeds to block 508. At block 508, the measurement trigger is identified. After block 508, the third exemplary embodiment 104c is concluded, and the method 100 proceeds as described below.

Referring again to FIG. 2, at block 106, if the measurement trigger is not identified at block 104, the method 100 proceeds to enter a standby state at block 108. If the measurement trigger is identified at block 104, the method 100 proceeds to block 110.

At block 110, the controller 14 uses the plurality of vehicle sensors 16 to perform a measurement of the environment surrounding the vehicle 12. In an exemplary embodiment, performing the measurement includes capturing one or more images of the environment surrounding the vehicle 12 using the camera system 24. In a non-limiting example, the one or more images are stored in the media 22 of the controller 14 for later retrieval. In another exemplary embodiment, performing the measurement further includes determining a location of the vehicle 12 corresponding to each of the one or more images using the GNSS 26. The location of the vehicle 12 is stored with the one or more images in the media 22 of the controller 14. In another exemplary embodiment, the performing the measurement further includes performing one or more measurements with the infrared sensor 28. After block 110, the method 100 proceeds to block 112.

At block 112, the controller 14 extracts information of importance from the one or more images captured at block 110. In the scope of the present disclosure, the information of importance includes adverse road conditions (i.e., a foreign object on the roadway, an animal on the roadway, water on the roadway, and/or a damaged roadway surface), a damaged traffic sign, a fire, criminal activity, graffiti, and/or a point-of-interest (POI). In an exemplary embodiment, the controller 14 uses a computer vision algorithm to extract the information of importance from the one or more images captured at block 110. In a non-limiting example, the computer vision algorithm utilizes machine learning techniques to analyze pixel-level information of an input image to detect and classify objects or patterns of interest. In a non-limiting example, the computer vision algorithm begins by preprocessing the input image through techniques such as, for example, image resizing, normalization, and/or filtering to reduce noise. Subsequently, the computer vision algorithm extracts relevant features from the input image using methods such as, for example, edge detection, corner detection, texture analysis, and/or the like. The computer vision algorithm may then utilize a machine learning model, such as, for example, a convolutional neural network (CNN), to classify and label relevant features of the input image based on learned patterns and associations. After block 112, the method 100 proceeds to block 114.

At block 114, the controller 14 determines a measurement classification of the measurement of the environment performed at block 110. In an exemplary embodiment, the measurement classification is determined based at least in part on the trigger request. For example, if the measurement of the environment performed at block 110 corresponds to a trigger request received from a law enforcement agency, as discussed above in reference to FIG. 4, the measurement classification is determined to be a law enforcement measurement classification. In another example, if the measurement of the environment performed at block 110 corresponds to a trigger request received from the occupant, as discussed above in reference to FIG. 4, the measurement classification is determined to be an occupant requested classification. In another example, if the measurement of the environment performed at block 110 corresponds to a trigger request received from a road maintenance agency, as discussed above in reference to FIG. 4, the measurement classification is determined to be a road maintenance measurement classification.

In another exemplary embodiment, the measurement classification is determined based at least in part on a content of the measurement of the environment performed at block 110. In a non-limiting example, the measurement of the environment performed at block 110 is analyzed using a computer vision algorithm to determine whether the measurement of the environment performed at block 110 contains a traffic sign. If the measurement of the environment performed at block 110 contains a traffic sign, the controller 14 then calculates a correlation value between the measurement of the environment performed at block 110 (i.e., one or more images captured by the camera system 24) and a reference image of an intact traffic sign using a computer vision algorithm. In the scope of the present disclosure, the correlation value quantifies a level of similarity between the measurement of the environment performed at block 110 and the reference image. The controller 14 subsequently compares the correlation value to a predetermined correlation threshold (e.g., 60%). If the correlation value is less than the predetermined correlation threshold, the traffic sign in the measurement of the environment performed at block 110 is determined include a damaged traffic sign. Therefore, the measurement classification is determined to be a damaged traffic sign measurement classification.

In another non-limiting example, damaged traffic signs are detected according to methods discussed in “Broken Detection of the Traffic Sign by using the Location Histogram Matching” by Yang et al. (Journal of Korea Multimedia Society, Vol. 15, No. 3 (pp. 312-322), March 2012), the entire contents of which is hereby incorporated by reference.

In another non-limiting example, the measurement of the environment performed at block 110 is analyzed using a machine learning algorithm to determine whether the measurement of the environment performed at block 110 contains an adverse road condition. In the scope of the present disclosure, the adverse road condition includes at least one of: a foreign object on the roadway, an animal on the roadway, water on the roadway, and/or a damaged roadway surface. If the measurement of the environment performed at block 110 contains an adverse road condition, the controller 14 then determines a risk value of the adverse road condition. In the scope of the present disclosure, the risk value quantifies a level of risk which the adverse road condition poses to vehicles on the roadway.

In an exemplary embodiment, to determine the risk value, the controller 14 uses a machine learning algorithm configured to determine risk values based on adverse road conditions. In an exemplary embodiment, the risk value is determined based on the type and severity of adverse road condition. In a non-limiting example, if the adverse road condition includes a complete obstruction of the roadway, the risk value is relatively higher than if the adverse road condition includes a minimal obstruction of the roadway.

The controller 14 subsequently compares the risk value to a predetermined risk value threshold. If the risk value is above the predetermined risk value threshold, the measurement classification is determined to be an adverse road condition measurement classification.

It should be understood that the measurement classification may be further specified based on the type of adverse road condition. For example, if the measurement of the environment performed at block 110 includes debris, such as, for example, garbage or litter, the measurement classification may be determined to be a debris measurement classification. In a non-limiting example, debris is detected according to methods discussed in “FRAMEWORK for Roadside Litter Identification and Face Recognition using Convolutional Neural Networks” by Abiga Sansuri et al. (Proceedings of ACM/CSI/IEEECS Research & Industry Symposium on IoT Cloud For Societal Applications (IoTCloud′21), the entire contents of which is hereby incorporated by reference.

If the measurement of the environment performed at block 110 includes an animal on the roadway, the measurement classification may be determined to be a roadkill measurement classification. If the measurement of the environment performed at block 110 includes water on the roadway, the measurement classification may be determined to be a flood measurement classification. In a non-limiting example, water on the roadway is detected according to methods discussed in “Water Detection with Segmentation Guided Dynamic Texture Recognition” by Santana et al. (2012 IEEE International Conference on Robotics and Biomimetics, ROBIO 2012-Conference Digest, December 2012), the entire contents of which is hereby incorporated by reference.

If the measurement of the environment performed at block 110 includes a damaged roadway surface (e.g., a pothole), the measurement classification may be determined to be a damaged roadway surface measurement classification. It should be understood that the debris measurement classification, the roadkill measurement classification, the flood measurement classification, and the damaged roadway surface measurement classification are determined in an analogous method to the adverse road condition measurement classification as discussed above.

In another non-limiting example, the measurement of the environment performed at block 110 is analyzed using a machine learning algorithm to determine whether the measurement of the environment performed at block 110 is indicative of a fire in the environment surrounding the vehicle 12. In a non-limiting example, if the measurement of the environment performed at block 110 includes thermal radiation measurements performed using the infrared sensor 28, the thermal radiation measurements are compared to a predetermined thermal radiation threshold. If one or more of the thermal radiation measurements are greater than or equal to the thermal radiation threshold, the measurement classification is determined to be a fire measurement classification. In another non-limiting example, if the measurement of the environment performed at block 110 includes one or more images captured by the camera system 24, a machine learning algorithm is used to detect fire in the one or more images. In another non-limiting example, fire is detected in the measurement of the environment performed at block 110 using methods discussed in “A Review on Early Forest Fire Detection Systems Using Optical Remote Sensing” by Barmpoutis et al. (Sensors, 20, 6442 Nov. 2020), the entire contents of which is hereby incorporated by reference.

In another non-limiting example, the measurement of the environment performed at block 110 is analyzed using a machine learning algorithm to determine whether the measurement of the environment performed at block 110 includes graffiti. In a non-limiting example, if the measurement of the environment performed at block 110 includes one or more images captured by the camera system 24, a machine learning algorithm is used to detect graffiti in the one or more images. In another non-limiting example, graffiti is detected in the measurement of the environment performed at block 110 using methods discussed in “Deep Learning-Based Graffiti Detection: A Study Using Images from the Streets of Lisbon” by Fogaça et al. (Applied Sciences, 13, 2249 Feb. 2023), the entire contents of which is hereby incorporated by reference. If the measurement of the environment performed at block 110 is determined to include graffiti, the measurement classification is determined to be a graffiti measurement classification.

In another non-limiting example, the measurement of the environment performed at block 110 is analyzed using a machine learning algorithm to determine whether the measurement of the environment performed at block 110 includes criminal activity (e.g., theft, vandalism, violence, and/or the like). In a non-limiting example, if the measurement of the environment performed at block 110 includes one or more images captured by the camera system 24, a machine learning algorithm is used to detect criminal activity in the one or more images. If the measurement of the environment performed at block 110 is determined to include criminal activity, the measurement classification is determined to be a criminal activity measurement classification.

In another exemplary embodiment, the measurement classification is determined based at least in part on the location of the measurement of the environment performed at block 110 as determined using the GNSS 26. In a non-limiting example, if the location of the measurement of the environment performed at block 110 is within a predetermined distance threshold (e.g., ten meters) from a POI (e.g., a museum, a statue, a monument, a memorial, a nature preserve, a tourist attraction, and/or the like), the measurement classification is determined to be a tourist measurement classification. In another non-limiting example, if the location of the measurement of the environment performed at block 110 is within a predetermined distance of one of a predetermined plurality of POI locations (e.g., stored in the media 22 of the controller 14), the measurement classification is determined to be the tourist measurement classification. In a non-limiting example, the measurement of the environment performed at block 110 (e.g., one or more images captured by the camera system 24) is analyzed using a machine learning algorithm to detect one or more points-of-interest (POIs) in the measurement of the environment performed at block 110. If one or more POIs are detected in the measurement of the environment performed at block 110, the measurement classification is determined to be the tourist measurement classification.

It should be understood that additional measurement classifications and sub-classifications useful for the purpose of providing information to authorities and/or for increasing occupant comfort and convenience are within the scope of the present disclosure. After block 114, the method 100 proceeds to block 116.

At block 116, the controller 14 uses the vehicle communication system 18 to transmit the measurement of the environment performed at block 110 (e.g., the one or more images captured using the camera system 24), the location of the measurement of the environment performed at block 110, and the measurement classification determined at block 114 to the remote server system 30. In an exemplary embodiment, the server controller 32 of the remote server system 30 uses the server communication system 36 to receive the measurement of the environment performed at block 110, the location of the measurement of the environment performed at block 110, and the measurement classification determined at block 114. The server controller 32 then stores the measurement of the environment performed at block 110, the location of the measurement of the environment performed at block 110, and the measurement classification determined at block 114 in the server database 34 for later retrieval.

In an exemplary embodiment, the measurement of the environment performed at block 110, the location of the measurement of the environment performed at block 110, and the measurement classification determined at block 114 are transmitted using a cellular data connection. In another exemplary embodiment, the measurement of the environment performed at block 110, the location of the measurement of the environment performed at block 110, and the measurement classification determined at block 114 are transmitted using a WiFi connection.

In another exemplary embodiment, the controller 14 compiles all measurements (e.g., images and/or videos) with the tourist measurement classification into a multimedia presentation (e.g., photo collage, a film, a slideshow, and/or the like) and displays the multimedia presentation to the occupant using, for example, an HMI of the vehicle 12. After block 116, the method 100 proceeds to block 118.

At block 118, the server controller 32 provides the measurement of the environment performed at block 110, the location of the measurement of the environment performed at block 110, and the measurement classification determined at block 114 stored in the server database 34 at block 116 to authorities. In an exemplary embodiment, authorities may establish a connection with the server controller 32 using the server communication system 36 and request measurements having particular measurement classifications and/or particular locations. In another exemplary embodiment, the server controller 32 uses the server communication system 36 to automatically transmit measurements having particular measurement classifications to particular authorities. In a non-limiting example, measurements having the law enforcement measurement classification, the graffiti measurement classification, and/or the criminal activity measurement classification are transmitted to a law enforcement agency.

In another non-limiting example, measurements having the road maintenance measurement classification, the damaged traffic sign measurement classification, the adverse road condition measurement classification, the debris measurement classification, the roadkill measurement classification, the flood measurement classification, and/or the damaged roadway surface measurement classification are transmitted to a road maintenance agency. In another non-limiting example, measurements having the fire measurement classification are transmitted to a fire department. After block 118, the method 100 proceeds to enter the standby state at block 108.

In another non-limiting example, the server controller 32 uses the server communication system 36 to provide an application programming interface (API) which allows authorities to send trigger requests and receive information stored in the server database 34.

In an exemplary embodiment, the controller 14 repeatedly exits the standby state 108 and restarts the method 100 at block 102. In a non-limiting example, the controller 14 exits the standby state 108 and restarts the method 100 on a timer, for example, every three hundred milliseconds.

The system 10 and method 100 of the present disclosure offer several advantages. Through collection and aggregation of road condition data, authorities may be promptly informed about issues requiring resolution. Using the method 100, the system 10 may take advantage of extra computing capacity to provide information to authorities. Additionally, by recording images and/or videos of POIs, the system 10 and method 100 may be used to increase occupant comfort and convenience.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for notifying an authority about road conditions for a vehicle, the system comprising:
a plurality of vehicle sensors;
a vehicle communication system; and
a controller in electrical communication with the plurality of vehicle sensors and the vehicle communication system, wherein the controller is programmed to:
identify a measurement trigger;
perform a measurement of an environment surrounding the vehicle using the plurality of vehicle sensors in response to identifying the measurement trigger;
determine a measurement classification based at least in part on the measurement; and
transmit the measurement and the measurement classification to a remote server system using the vehicle communication system.

2. The system of claim 1, wherein the plurality of vehicle sensors includes at least a global navigation satellite system (GNSS), and wherein to identify the measurement trigger, the controller is further programmed to:
determine a location of the vehicle using the GNSS;
compare the location of the vehicle to a predetermined geofenced location area; and
identify the measurement trigger in response to determining that the location of the vehicle is within the predetermined geofenced location area.

3. The system of claim 1, wherein to identify the measurement trigger, the controller is further programmed to:
receive a trigger request from at least one of: an occupant of the vehicle and an authority; and
identify the measurement trigger based at least in part on the trigger request.

4. The system of claim 3, wherein the plurality of vehicle sensors includes at least a camera system, and wherein to perform the measurement of the environment surrounding the vehicle, the controller is further programmed to:
capture one or more images of a remote vehicle using the camera system based at least in part on the trigger request, wherein the trigger request includes at least one of: a remote vehicle license plate number, a remote vehicle model, and a remote vehicle color.

5. The system of claim 4, wherein to determine the measurement classification, the controller is further programmed to:
determine the measurement classification of the one or more images to be a law enforcement measurement classification in response to determining that remote vehicle in the one or more images includes at least one of: the remote vehicle license plate number, the remote vehicle model, and the remote vehicle color.

6. The system of claim 1, wherein to identify the measurement trigger, the controller is further programmed to:
perform a trigger measurement using the plurality of vehicle sensors;
identify a road condition in the trigger measurement using a machine learning algorithm, wherein the road condition includes one of: a normal road condition and an abnormal road condition; and
identify the measurement trigger in response to determining that the road condition is the abnormal road condition.

7. The system of claim 1, wherein the plurality of vehicle sensors includes at least a camera system, and wherein to perform the measurement of the environment surrounding the vehicle, the controller is further programmed to:
capture one or more images using the camera system; and
store the one or more images in a non-transitory memory of the controller.

8. The system of claim 7, wherein the plurality of vehicle sensors includes at least a global navigation satellite system (GNSS), and wherein to determine the measurement classification, the controller is further programmed to:
determine a location of the vehicle using the GNSS;
compare the location of the vehicle to a predetermined plurality of point-of-interest (POI) locations; and
determine the measurement classification of the one or more images to be a tourist measurement classification in response to determining that the location of the vehicle is within a predetermined distance from at least one of the plurality of POI locations.

9. The system of claim 7, wherein to determine the measurement classification, the controller is further programmed to:
identify a traffic sign in the one or more images using a computer vision algorithm;
calculate a correlation value between the one or more images and a reference image using the computer vision algorithm; and
determine the measurement classification of the one or more images to be a damaged traffic sign measurement classification in response to identifying the traffic sign in the one or more images and in response to determining that the correlation value is less than a predetermined correlation threshold.

10. The system of claim 7, wherein to determine the measurement classification, the controller is further programmed to:
detect an adverse road condition in the one or more images using a machine learning algorithm, wherein the adverse road condition includes at least one of: a foreign object on a roadway, an animal on the roadway, and a damaged roadway surface;
determine a risk value of the adverse road condition; and
determine the measurement classification of the one or more images to be an adverse road condition measurement classification based at least in part on the adverse road condition and the risk value.

11. A method for notifying an authority about road conditions for a vehicle, the method comprising:
performing a measurement of an environment surrounding the vehicle using a plurality of vehicle sensors;
determining a measurement classification based at least in part on the measurement; and
transmitting the measurement and the measurement classification to an authority.

12. The method of claim 11, wherein performing the measurement and determining the measurement classification further comprises:
capturing one or more images of the environment surrounding the vehicle using a camera system;
detecting debris in the one or more images using a machine learning algorithm;
determining a risk value of the debris; and
determining the measurement classification of the one or more images to be a debris measurement classification based at least in part on the debris and the risk value.

13. The method of claim 11, wherein performing the measurement and determining the measurement classification further comprises:
performing one or more measurements of the environment surrounding the vehicle using an infrared sensor configured to detect thermal radiation;
detecting fire in the environment surrounding the vehicle based at least in part on the one or more measurements; and
determining the measurement classification of the one or more measurements to be a fire measurement classification in response to detecting fire in the environment surrounding the vehicle.

14. The method of claim 11, wherein performing the measurement and determining the measurement classification further comprises:
capturing one or more images of the environment surrounding the vehicle using a camera system;
detecting graffiti in the one or more images using a machine learning algorithm; and
determining the measurement classification of the one or more images to be a graffiti measurement classification in response to detecting graffiti in the one or more images.

15. The method of claim 11, wherein performing the measurement and determining the measurement classification further comprises:
capturing one or more images of the environment surrounding the vehicle using a camera system;
detecting criminal activity in the one or more images using a machine learning algorithm; and
determining the measurement classification of the one or more images to be a criminal activity measurement classification in response to detecting criminal activity in the one or more images.

16. The method of claim 11, wherein performing the measurement and determining the measurement classification further comprises:
capturing one or more images of the environment surrounding the vehicle using a camera system;
detecting water on a roadway in the one or more images using a machine learning algorithm; and
determining the measurement classification of the one or more images to be a flood measurement classification in response to detecting water on the roadway in the one or more images.

17. The method of claim 11, wherein performing the measurement and determining the measurement classification further comprises:
capturing a plurality of images of the environment surrounding the vehicle using a camera system;
detecting one or more points-of-interest (POIs) in the plurality of images using a machine learning algorithm;
determining the measurement classification of the plurality of images to be a tourist measurement classification in response to detecting the one or more POIs in the plurality of images;
generating a film including the plurality of images; and
displaying the film to an occupant of the vehicle.

18. A system for notifying an authority about road conditions for a vehicle, the system comprising:
a camera system;
a global navigation satellite system (GNSS);
a vehicle communication system; and
a controller in electrical communication with the camera system, the GNSS, and the vehicle communication system, wherein the controller is programmed to:
identify a measurement trigger;
capture one or more images of an environment surrounding the vehicle using the camera system in response to identifying the measurement trigger;
determine a location of each of the one or more images using the GNSS;
determine a measurement classification of each of the one or more images; and
transmit the one or more images, the measurement classification of each of the one or more images, and the location of each of the one or more images to a remote server system using the vehicle communication system, wherein the remote server system is configured to be accessed by the authority.

19. The system of claim 18, the measurement trigger includes at least one of: a predetermined geofenced location area, a trigger request initiated by an occupant of the vehicle, and a trigger request sent by the authority.

20. The system of claim 19, wherein to determine the measurement classification, the controller is further programmed to:
identify a road condition in the one or more images, wherein the road condition includes at least one of: a point-of-interest (POI), a damaged traffic sign, a foreign object on a roadway, an animal on the roadway, a damaged roadway surface, a fire in the environment surrounding the vehicle, graffiti, criminal activity, and water on the roadway; and
determine the measurement classification based at least in part on the road condition in the one or more images.
